(19) United States
(12) Patent Application Publication
(10) Pub. No.: US 2026/0063662 A1
(43) Pub. Date: Mar. 5, 2026

(54) INERTIAL SENSORS WITH BULK SUBSTRATE PROOF MASS

(71) Applicant: Analog Devices, Inc., Wilmington, MA (US)

(72) Inventors: Kemiao Jia, Glastonbury, CT (US); Benoit Dufort, Hampton, NH (US); Gaurav Vohra, Sudbury, MA (US); Xin Zhang, Acton, MA (US); Christine Tsau, Belmont, MA (US)

(21) Appl. No.: 19/317,856

(22) Filed: Sep. 3, 2025

Related U.S. Application Data
(60) Provisional application No. 63/690,461, filed on Sep. 4, 2024.

(51) Int. Cl. G01P 15/125; G01P 15/08

(52) U.S. Cl. CPC G01P 15/125; G01P 2015/0862

(57) ABSTRACT

Inertial sensors with a bulk substrate proof mass are disclosed herein. In certain embodiments, an inertial sensor includes a bulk substrate and a bulk substrate proof mass formed from the bulk substrate. Additionally, the inertial sensor further includes a sensing structure that detects a relative motion between the bulk substrate and the bulk substrate proof mass. Accordingly, a portion of the bulk substrate is used to form the proof mass, which moves in a cavity relative to another portion of the bulk substrate that is fixed. Such an inertial sensor can provide a number of benefits including, for example, lower stiction risk, stiffer tethering, and/or lower Brownian noise.

### INCORPORATION BY REFERENCE TO ANY PRIORITY APPLICATIONS

The present application claims priority to U.S. Provisional Patent Application No. 63/690,461, filed Sep. 4, 2024, and titled “INERTIAL SENSORS WITH BULK SUBSTRATE PROOF MASS,” the entirety of which is hereby incorporated herein by reference.

### FIELD OF THE DISCLOSURE

Embodiments of the invention relate to electronics, and more particularly, to microelectromechanical systems (MEMS).

### BACKGROUND

A MEMS inertial sensor, such as a MEMS accelerometer or a MEMS gyroscope, includes a proof mass that moves in response to inertial forces.

In one example, an accelerometer includes a proof mass suspended by spring tethers over a substrate. Additionally, a sensing structure measures a deflection of the proof mass resulting in a sensor output with amplitude proportional to acceleration.

In another example, a gyroscope includes a proof mass that moves in a first direction (for example an X-direction) while a sensing structure detects a Coriolis effect in a second direction (for example, a Y-direction) arising from movement of the proof mass.

### SUMMARY OF THE DISCLOSURE

Inertial sensors with a bulk substrate proof mass are disclosed herein. In certain embodiments, an inertial sensor includes a bulk substrate and a bulk substrate proof mass formed from the bulk substrate. Additionally, the inertial sensor further includes a sensing structure that detects a relative motion between the bulk substrate and the bulk substrate proof mass. Accordingly, a portion of the bulk substrate is used to form the proof mass, which moves in a cavity relative to another portion of the bulk substrate that is fixed. Such an inertial sensor can provide a number of benefits including, for example, lower stiction risk, stiffer tethering, and/or lower Brownian noise.

In one aspect, an inertial sensor is provided. The inertial sensor includes a bulk substrate, a bulk substrate proof mass formed from a portion of the bulk substrate, and a sensing structure configured to detect a relative motion between the bulk substrate and the bulk substrate proof mass.

In another aspect, a method of forming an inertial sensor is disclosed. The method includes forming a bulk substrate proof mass from a portion of a bulk substrate, and forming a sensing structure coupled to the bulk substrate, the capacitance sensing structure detecting a relative motion between the bulk substrate and the bulk substrate proof mass.

### BRIEF DESCRIPTION OF THE DRAWINGS

FIG. 1 is a cross-section of one embodiment of a MEMS inertial sensor.

FIG. 2A is a plan view of one embodiment of an XY axis accelerometer with bulk substrate proof mass.

FIG. 2B is a cross section of the XY axis accelerometer of FIG. 2A taken along the lines 2B-2B.

FIG. 3 is a plan view of one embodiment of a Z axis accelerometer with bulk substrate proof mass.

FIG. 4 is a plan view of another embodiment of a Z axis accelerometer with bulk substrate proof mass.

FIG. 5 is a plan view of another embodiment of an XY axis accelerometer with bulk substrate proof mass.

FIG. 6 is a plan view of another embodiment of a Z axis accelerometer with bulk substrate proof mass.

FIG. 7A is an example of a fully differential accelerometer using two proof masses.

FIG. 7B is an example of a fully differential accelerometer using a single proof mass.

FIG. 8A is a plan view of another embodiment of a Z axis accelerometer with bulk substrate proof mass.

FIG. 8B is a cross section of the Z axis accelerometer of FIG. 8A taken along the lines 8B-8B.

FIG. 8C is a cross section of another embodiment of a Z axis accelerometer taken along the lines 8B-8B.

FIG. 9A is a plan view of another embodiment of a Z axis accelerometer with bulk substrate proof mass.

FIG. 9B is a cross section of the Z axis accelerometer of FIG. 9A taken along the lines 9B-9B.

FIG. 9C is a cross section of the Z axis accelerometer of FIG. 9A taken along the lines 9C-9C.

FIG. 9D is a cross section of another embodiment of a Z axis accelerometer taken along the lines 9B-9B.

FIG. 9E is a cross section of another embodiment of a Z axis accelerometer taken along the lines 9C-9C.

FIG. 10 is a plan view of another embodiment of a Z axis accelerometer with bulk substrate proof mass.

FIG. 11 is a plan view of one embodiment of a gyroscope with bulk substrate proof mass.

### DETAILED DESCRIPTION OF EMBODIMENTS

The following detailed description of embodiments presents various descriptions of specific embodiments of the invention. However, the invention can be embodied in a multitude of different ways. In this description, reference is made to the drawings where like reference numerals may indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

MEMS inertial sensors, such as MEMS accelerometers and MEMS gyroscopes, include a proof mass that moves in response to inertial forces. Additionally, the MEMS inertial sensor can include a sensing structure, such as a capacitive sensing structure having a first set of fingers (moveable fingers) attached to the proof mass that move with respect to a second set of fingers (fixed fingers) anchored to a substrate. The moveable fingers and the fixed fingers can be interdigitated to form comb finger sets that serve as a capacitance sensing structure. In other examples, the sensing structure can be implemented using piezo sensing or other suitable structures.

Inertial sensors with a bulk substrate proof mass are disclosed herein. In certain embodiments, an inertial sensor includes a bulk substrate and a bulk substrate proof mass formed from the bulk substrate. Additionally, the inertial sensor further includes a sensing structure that detects a relative motion between the bulk substrate and the bulk substrate proof mass.

Accordingly, a portion of the bulk substrate is used to form the proof mass, which moves in a cavity relative to another portion of the bulk substrate that is fixed. Such an inertial sensor can provide a number of benefits including, for example, lower stiction risk, stiffer tethering, and/or lower Brownian noise. The proof mass can be formed from the bulk substrate using any suitable fabrication techniques, such as using patterning and etching processes.

The bulk substrate can be a bulk silicon (Si) substrate in some implementations. However, other implementations are possible, such as configurations in which the bulk substrate is formed as a bulk glass substrate, a bulk silicon carbide (SiC), or another suitable bulk substrate for MEMS processing.

In certain implementations, mechanical elements, such as the proof mass and tethers, are formed from the bulk substrate while electrical elements, such as the sensing structure and electrode plates, are formed from a separate processing layer. In some implementations, the processing layer is formed over the bulk substrate. However, other implementations are possible, such as configurations in which the separate processing layer is below or positioned between portions of the bulk substrate.

The separate processing can include any suitable processing layer for electrical elements in a MEMS process. For instance, in one embodiment, the bulk substrate is a bulk silicon substrate from which a bulk silicon proof mass is formed, and a polysilicon layer is formed over the bulk silicon substrate and includes a capacitance sensing structure formed as polysilicon comb finger sets. However, other implementations are possible, such as configurations using a different type of bulk substrate, a different type of processing layer, a different location for the processing layer, and/or a different type of sensing structure (for instance, piezoelectric or piezoresistive) is used.

Implementing the electrical elements on a separate processing layer from the mechanical elements serves to decouple the electrical elements from the mechanical elements. Such decoupling allows for full differential sensing using a single proof mass. Decoupling can also provide improved long-term stability (for instance, enhanced stability performance in response to an acceleration random walk and/or acceleration ramp). Moreover, decoupling electrical and mechanical elements lowers parasitic capacitance associated with sensing nodes, thereby improving electrical noise.

In certain implementations, the bulk substrate includes a lower or handle region and an upper region that is over the handle region. Additionally, the bulk substrate proof mass can be formed from the upper region of the bulk substrate, while the handle region can serve as a bottom cap for encapsulation purposes. In some implementations, a top cap is formed over the sensing structure to form an encapsulation that surrounds the proof mass and the sensing structure. Thus, electrical elements and mechanical elements can be encapsulated as desired for improved robustness.

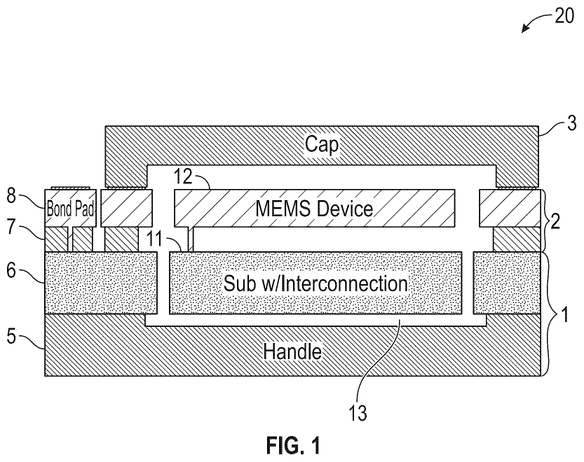

FIG. 1 is a cross-section of one embodiment of a MEMS inertial sensor 20. The MEMS inertial sensor 20 includes a bulk substrate 1, processing layers 2, and a cap 3.

As shown in FIG. 1, the bulk substrate 1 has been processed to form mechanical elements, such as a bulk substrate proof mass 11 that is suspended in a cavity 13. The bulk substrate proof mass 11 moves relative to a fixed portion of the bulk substrate 1. In this example, the bulk substrate 1 includes a lower or handle region 5 that serves as a bottom cap for encapsulation, and an upper region 6 from which the bulk substrate proof mass 11 is formed. The bulk substrate proof mass 11 can also serve as a stress isolated platform for the MEMS device element 12, in this embodiment.

The bulk substrate 1 is shown as including the lower region 5 and the upper region 6, which are graphically depicted using different fill patterns in FIG. 1. Although shown with different fill patterns for assistance of the reader and for clarity of the figures, the upper region 6 and the lower region 5 are part of the same bulk substrate 1, and thus in some implementations are of the same material (for instance, silicon, silicon carbide, glass, or another suitable material used to implement the bulk substrate 1). In other implementations, they are of different materials. The lower region 5 and the upper region 6 can be bonded together using wafer bonding or other suitable process for forming the bulk substrate 1. Such wafer bonding can be used for implementations in which the lower region 5 and the upper region 6 are different materials as well as for implementations in which the lower region 5 and the upper region are the same material (for instance, silicon to silicon fusion bonding).

With continuing reference to FIG. 1, electrical elements 12 are formed in an electrical layer 8 of the processing layers 2. Additionally, a dielectric layer 7 is provided between the electrical layer 8 and the bulk substrate 1 (including between electrical layer 12 and bulk substrate proof mass 11). The dielectric layer 7 can be patterned in a wide variety of ways and can also be present between portions of the electrical layer 8 over the bulk substrate proof mass 11.

In this example, the processing layers 2 are formed over the bulk substrate 1. However, other implementations are possible, such as configurations in which one or more processing layers are formed below or between portions of the bulk substrate 1. Further, although an example with two processing layers is shown, any number of processing layers can be included for forming the electrical elements. The processing layers can include a wide variety of materials including, for example, metal and/or polysilicon layers for electrical conduction and dielectric layers such as silicon dioxide electrical insulation. A wide variety of material types can be using depending on the specific MEMS processing technology from which the MEMS inertial sensor 20 is formed.

Further, a material composition of the bulk substrate 1 can depend on the MEMS processing technology used. In one embodiment, the bulk substrate 1 is silicon. In another embodiment, the bulk substrate 1 is silicon carbide. In yet another embodiment, the bulk substrate 1 is glass.

In the illustrated embodiment, a stress isolation platform has been used as the proof mass. Such a proof mass can be suspended in the cavity 13 using tethers. Further, a sensing structure (for instance, capacitance, piezoelectric, piezoresistive, etc.) can include sensing structures, for instance, movable electrodes anchored to the platform and fixed electrodes anchored outside of the isolation platform.

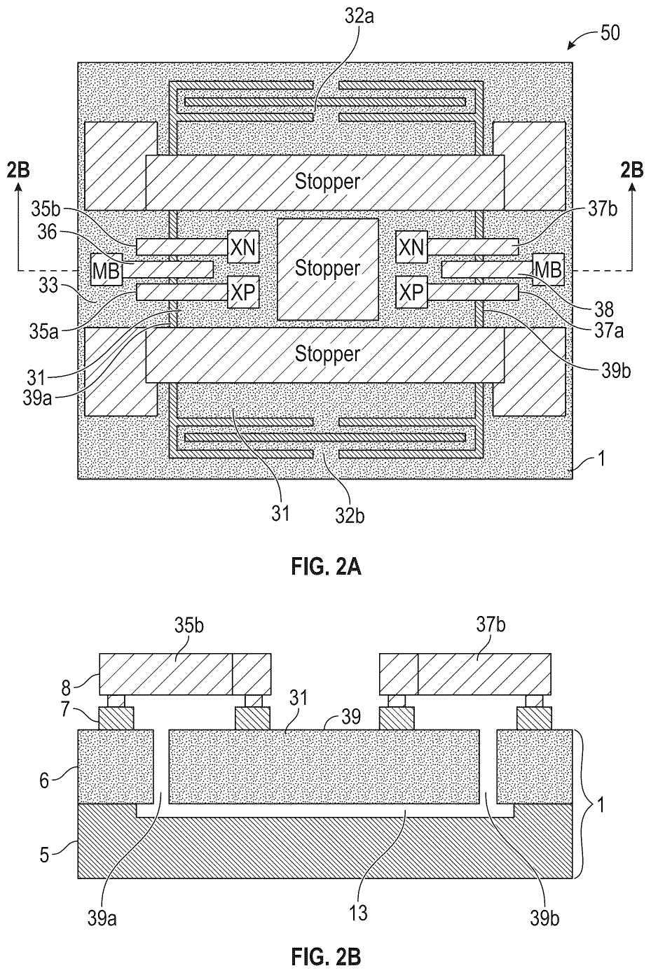

FIG. 2A is a plan view of one embodiment of an XY axis accelerometer 50 with bulk substrate proof mass 31. FIG. 2B is a cross section of the XY axis accelerometer 50 of FIG. 2A taken along the lines 2B-2B.

In the embodiment of FIGS. 2A and 2B, a single XY axis accelerometer is depicted. However, skilled artisans will appreciate that the accelerometer 50 can be rotated to function as a YX axis accelerometer.

With reference to FIGS. 2A and 2B, the XY axis accelerometer 50 includes a bulk substrate 1 that has been patterned to form a bulk substrate proof mass 31 that is suspended in a cavity 13. The bulk substrate proof mass 31 is suspended by a first spring tether 32a and a second spring tether 32b, which are also formed from the bulk substrate 1.

The XY axis accelerometer 50 also includes various electrical elements patterned in a processing layer 8 that is formed over the bulk substrate 1 and the dielectric layer 7. The processing layer 8 can include a wide variety of materials, including, but not limited to, polysilicon, SiC, metal, and/or another suitable material. The electrical elements include a capacitance sensing structure that includes a first set of moveable fingers 35a/35b that move relative to fixed finger 36 and a second set of moveable fingers 37a/37b that move relative to a fixed finger 38. The moveable fingers 35a/35b/37a/37b are attached to the bulk substrate proof mass 31 while the fixed fingers 36/38 are attached to a fixed portion of the bulk substrate 1.

Although an example of a capacitance sensing structure is shown, the teachings herein are also applicable to other types of sensing structures, including, but not limited to, piezoelectric and/or piezoresistive structures.

With continuing reference to FIGS. 2A and 2B, the moveable fingers 35a/35b and fixed finger 36 run parallel to a top surface 39 of the bulk substrate proof mass 31 over a first trench 39a formed in the bulk substrate 1, while the moveable fingers 37a/37b and fixed finger 38 run parallel to a top surface 39 of the bulk substrate proof mass 31 over a second trench 39b formed in the bulk substrate 1. Although an example in which the sensing structure runs parallel to the proof mass is shown, sensing structures can be orientated in other ways, for instance, vertically.

The XY axis accelerometer 50 also includes various stopper regions formed from the processing layer 8, in this example. The in-plane stopper region is not shown in the cross-section of FIG. 2B for clarity of the figure. Referring back to FIG. 1, the out of plane stoppers can be implemented using handle region 5 and cap layer 3.

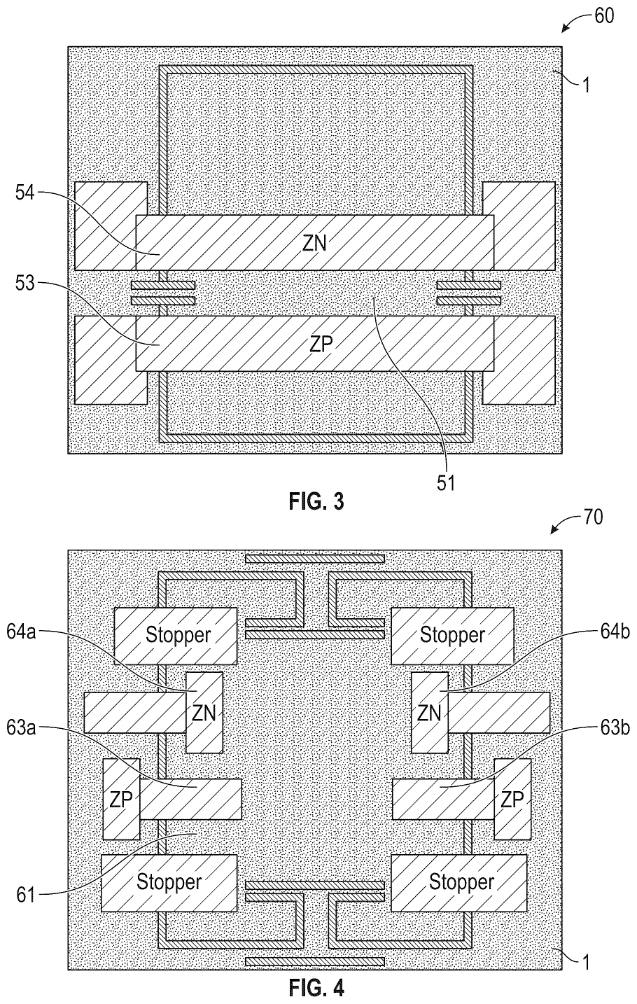

FIG. 3 is a plan view of one embodiment of a Z axis accelerometer 60 with bulk substrate proof mass 51. The Z axis accelerometer 60 can function with a teeter totter motion, in this example.

The Z axis accelerometer 60 includes the bulk substrate proof mass 51, which is formed from a portion of a bulk substrate 1. The Z axis accelerometer 60 includes a capacitive sensing structure that includes a first electrode 53 and a second electrode 54. The electrodes 53/54 can be formed from a processing layer provided over the bulk substrate 1. Referring back to FIG. 1, in some implementations the Z axis accelerometer of FIG. 3 can use the handle region 5 and the cap layer 3 as the out of plane stoppers, while in plane stoppers can be similarly implemented as in FIG. 2A.

FIG. 4 is a plan view of another embodiment of a Z axis accelerometer 70 with bulk substrate proof mass 61. The Z axis accelerometer 60 includes the bulk substrate proof mass 51, which is formed from a portion of a bulk substrate 1. The Z axis accelerometer 60 includes a capacitive sensing structure that includes first electrodes 63a/63b and second electrodes 64a/64b, which can be formed from a processing layer provided over the bulk substrate 1. The Z axis accelerometer 70 also includes various stopper regions, which can also be formed from either the processing layer or the handle/cap layers.

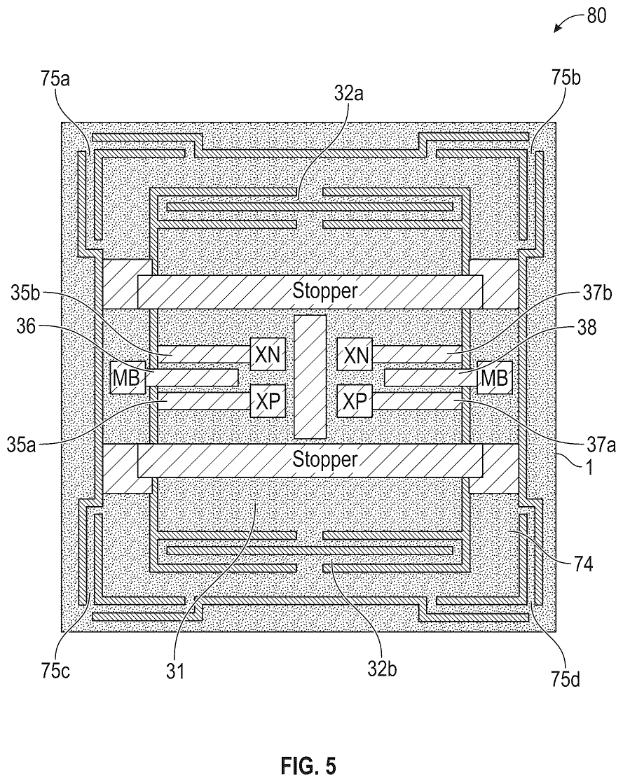

FIG. 5 is a plan view of another embodiment of an XY axis accelerometer 80 with bulk substrate proof mass 31.

The XY axis accelerometer 80 of FIG. 5 is similar to the XY axis accelerometer 50 of FIGS. 2A and 2B, except that the XY axis accelerometer 80 further includes a frame 74 that is formed from the bulk substrate 1. As shown in FIG. 5, the frame 74 is attached to a fixed portion of the bulk substrate 1 using supports 75a/75b/75c/75d. The frame 74 is stress isolated, in this example. The supports 75a/75b/75c/75d aid in suspending the frame 74 and the bulk substrate proof mass 31 over a cavity. The bulk substrate proof mass 31 is attached to the frame 74 by a first spring tether 32a and a second spring tether 32b, which are also formed from the bulk substrate 1.

The XY axis accelerometer 80 of FIG. 5 includes a capacitance sensing structure similar to that of the XY axis accelerometer 50 of FIGS. 2A and 2B, except that in FIG. 5 the fixed fingers 36/38 are attached to the frame 74.

Including a frame in an inertial sensor with bulk substrate proof mass can provide an improvement in stress isolation relative to an implementation without a frame.

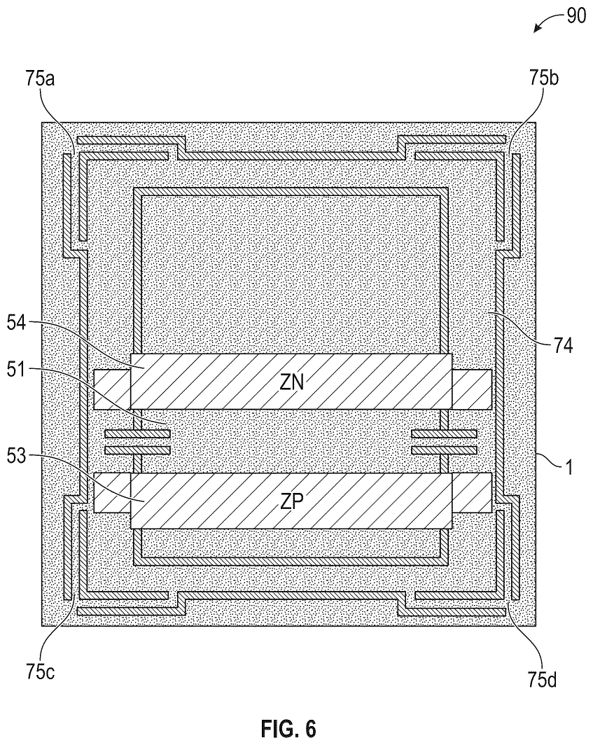

FIG. 6 is a plan view of another embodiment of a Z axis accelerometer 90 with bulk substrate proof mass 51. The Z axis accelerometer 90 of FIG. 6 is similar to the Z axis accelerometer 60 of FIG. 3, except that the Z axis accelerometer 90 of FIG. 6 further includes a frame 74 to which the bulk substrate proof mass 51 is attached to. Additionally, the frame 74 is attached to a fixed portion of the bulk substrate 1 using supports 75a/75b/75c/75d.

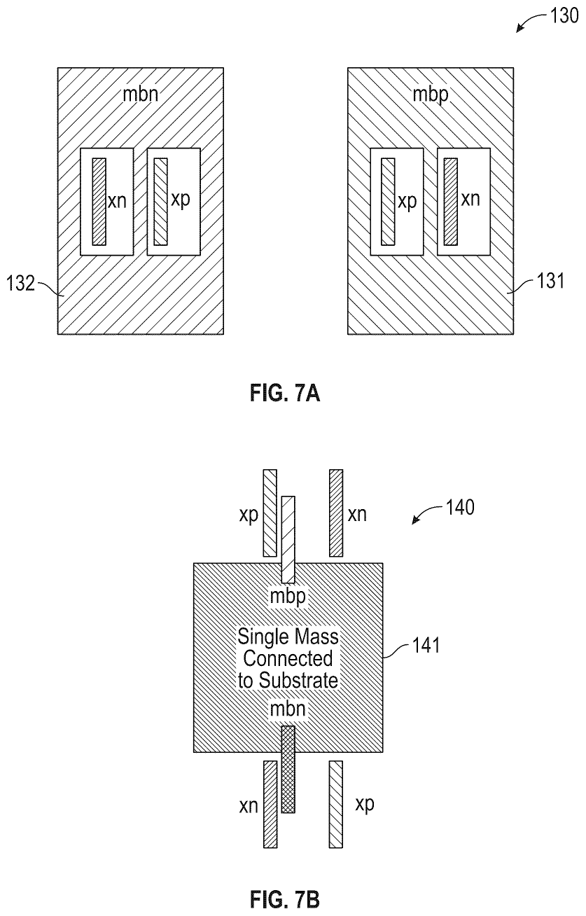

FIG. 7A is an example of a fully differential accelerometer 130 using two proof masses. As shown in FIG. 7A a motion of a first proof mass 131 is used to generate a first component mbp of a differential output signal, while a motion of a second proof mass 132 is used to generate a second component mbn of the differential output signal. In this example, the mbp/mbn electrodes move relative to fixed xp/xn electrodes.

FIG. 7B is an example of a fully differential accelerometer using a single proof mass 141. As shown in FIG. 7B a motion of the single proof mass 141 is used to generate both a first component mbp of a differential output signal and a second component mbn of the differential output signal. In this example, the mbp/mbn electrodes move relative to fixed xp/xn electrodes.

With continuing reference to FIG. 7B, the inertial sensors herein can generate a differential output signal using a single proof mass due to decoupling of the electrical elements and the mechanical elements on different layers. For example, the proof mass can be formed from a bulk substrate, while the electrical elements can be formed from a polysilicon layer provided over the bulk substrate. Thus, rather than being limited to the two proof mass configuration of FIG. 7A, the inertial sensors herein can be implemented to operate with a single proof mass.

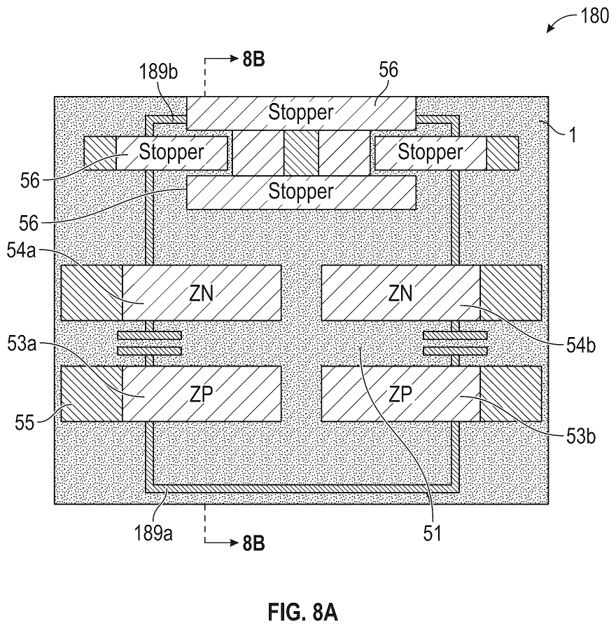

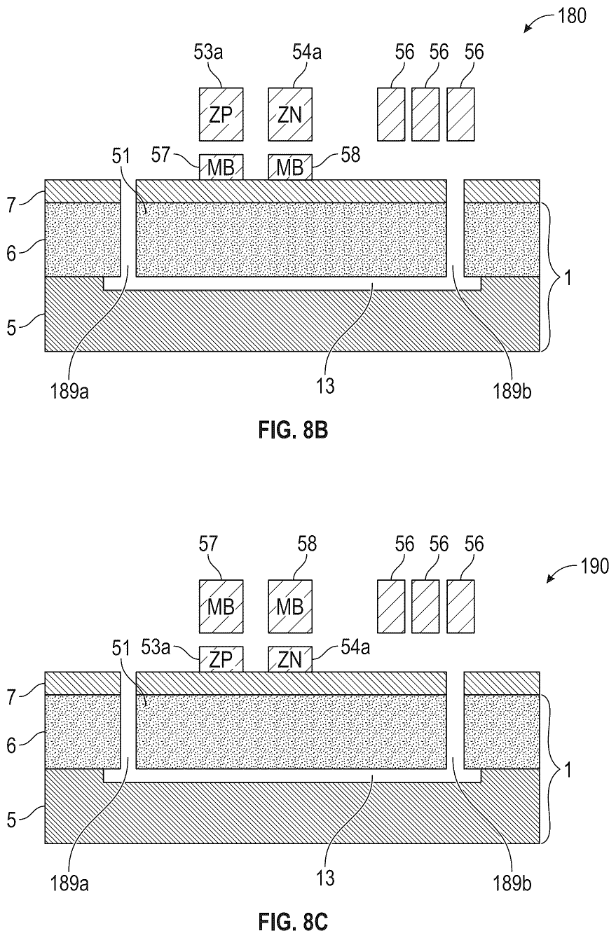

FIG. 8A is a plan view of another embodiment of a Z axis accelerometer 180 with bulk substrate proof mass 51. FIG. 8B is a cross section of the Z axis accelerometer 180 of FIG. 8A taken along the lines 8B-8B.

The Z axis accelerometer 180 of FIGS. 8A and 8B is similar to the Z axis accelerometer 60 of FIG. 3, except that the ZN electrode of FIG. 3 is partitioned into a first ZN electrode 54a and a second ZN electrode 54b, while the ZP electrode of FIG. 3 is partitioned into a first ZP electrode 53a and a second ZP electrode 53b. Additionally, the Z axis accelerometer 180 of FIGS. 8A and 8B depicts an example of stopper elements 56 and anchors 55. Although a specific example of stoppers and anchoring is shown, any suitable implementation of stopper elements and anchors can be used.

As shown in FIG. 8B, the bulk substrate proof mass 51 is suspended over a cavity 13 and is surrounded by trenches 189a/189b that separate the sides of the bulk substrate proof mass 51 from the rest of the upper region 6 of the bulk substrate 1. The first ZP electrode 53a and the first ZN electrode 54a are positioned over a first MB electrode 57 and second MB electrode 58, respectively, which are attached to the bulk substrate proof mass 51. Thus, as the bulk substrate proof mass 51 moves the first ZP electrode 53a and the first MB electrode 57 form a first electrode pair for sensing deflection, while the first ZN electrode 54a and the second MB electrode 58 form a second electrode pair for sensing deflection.

FIG. 8C is a cross section of another embodiment of a Z axis accelerometer 190 taken along the lines 8B-8B. The cross-section of FIG. 8C is similar to the cross-section of FIG. 8B except that the position of the ZP/ZN electrodes 53a/54a and MB electrodes 57/58 is reversed. Thus, the ZP/ZN electrodes 53a/54a are attached to the bulk substrate proof mass 51, in this embodiment. Thus, the Z axis accelerometer 190 operates with rotor-stator reversed in an electrical sense. Such rotor-stator reversal is applicable not only to Z axis sensors, but to XY sensors as well. For example, with respect to the embodiments of FIGS. 7A and 7B, rather than placing the mbp/mbn electrodes on the moveable mass and fixing the xp/xn electrodes, the xp/xn electrodes can be placed on the moveable mass and move with respect to fixed mbp/mbn electrodes.

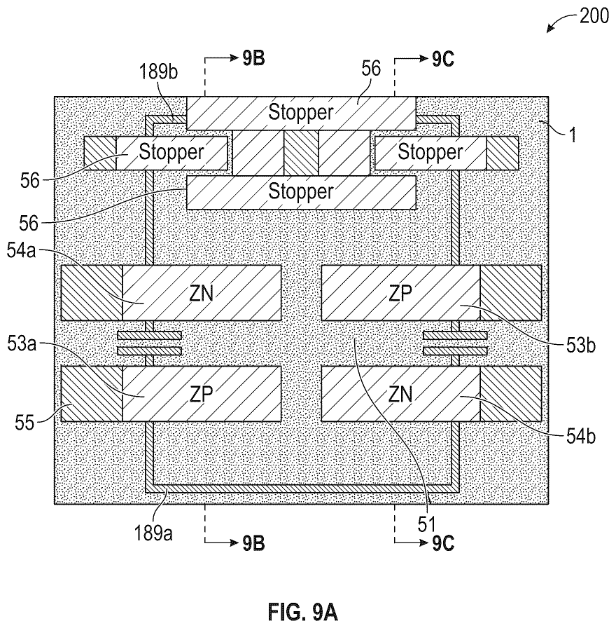

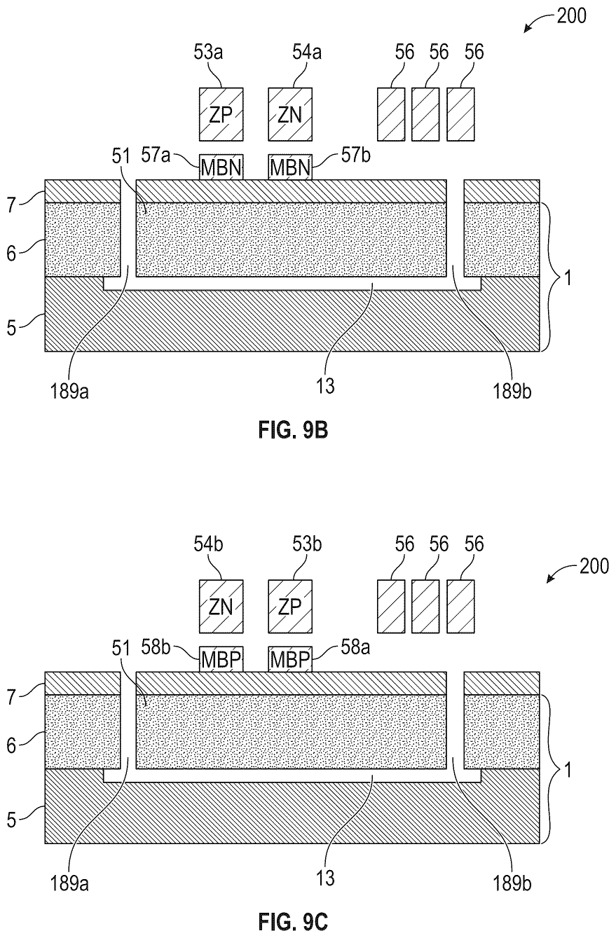

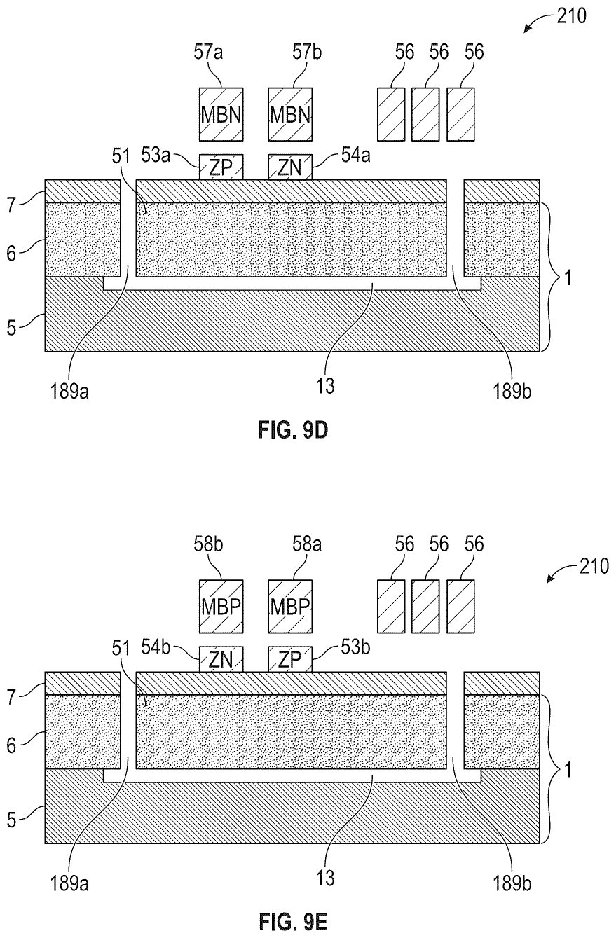

FIG. 9A is a plan view of another embodiment of a Z axis accelerometer 200 with bulk substrate proof mass. FIG. 9B is a cross section of the Z axis accelerometer 200 of FIG. 9A taken along the lines 9B-9B. FIG. 9C is a cross section of the Z axis accelerometer 200 of FIG. 9A taken along the lines 9C-9C.

The Z axis accelerometer 200 of FIGS. 9A-9C is similar to the Z axis accelerometer 180 of FIGS. 8A-8B, except that the Z axis accelerometer 200 depicts an implementation of electrodes for fully differential sensing. As shown in FIG. 9B, the first ZP electrode 53a and the first ZN electrode 54a are positioned over a first MBN electrode 57a and second MBN electrode 57b, respectively, which are attached to the bulk substrate proof mass 51. Additionally, as shown in FIG. 9C, the second ZP electrode 53b and the second ZN electrode 54b are positioned over a first MBP electrode 58a and second MBP electrode 58b, respectively, which are attached to the bulk substrate proof mass 51.

FIG. 9D is a cross section of another embodiment of a Z axis accelerometer 210 taken along the lines 9B-9B. FIG. 9E is a cross section of another embodiment of a Z axis accelerometer 210 taken along the lines 9C-9C.

In comparison to the Z axis accelerometer 200 of FIGS. 9A-9C, the Z axis accelerometer 210 of FIGS. 9D-9E reverses the position of the ZP/ZN electrodes relative to the MBP/MBN electrodes. Thus, the ZP electrodes 53a/53b and the ZN electrodes 54a/54b are attached to the bulk substrate proof mass 51, in this embodiment.

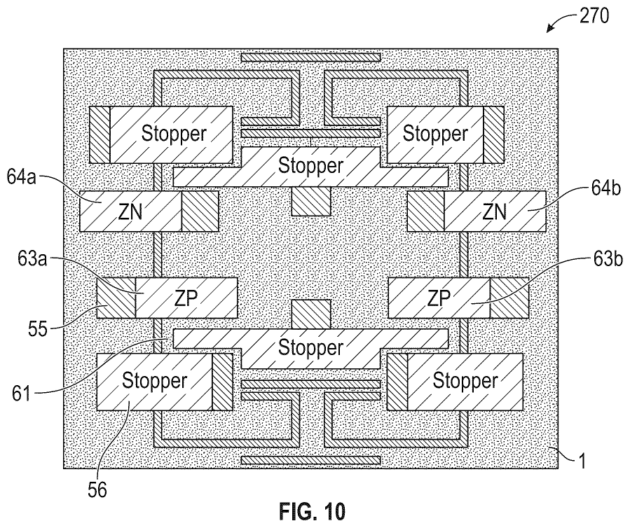

FIG. 10 is a plan view of another embodiment of a Z axis accelerometer 270 with bulk substrate proof mass 61. The Z axis accelerometer 270 of FIG. 10 is similar to the Z axis accelerometer 70 of FIG. 4, except that Z axis accelerometer 270 of FIG. 10 depicts an example of stopper elements 56 and anchors 55. Although a specific example of stoppers and anchoring is shown, any suitable implementation of stopper elements and anchors can be used.

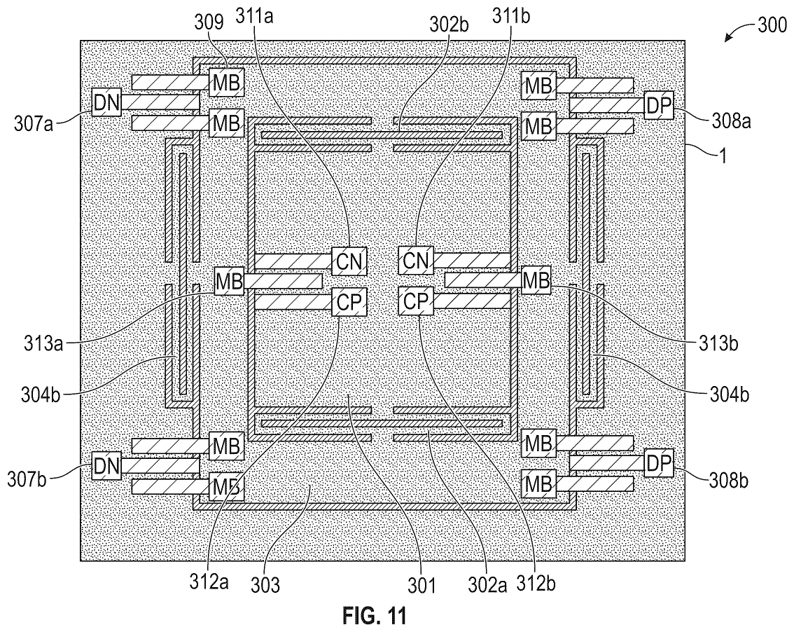

FIG. 11 is a plan view of one embodiment of a gyroscope 300 with bulk substrate proof mass 301. The bulk substrate proof mass 301 and a frame 303 are suspended over a cavity. Additionally, a first spring tether 302a and a second spring tether 302b couple the bulk substrate proof mass 301 to the frame 303, and a motion of the bulk substrate proof mass 301 is sensed using MB electrodes 313a/313b, CN electrodes 311a/311b, and CP electrodes 312a/312b, which collective form sets of comb sensing electrodes.

The frame 303 is coupled to the bulk substrate 1 by spring tethers 304a/304b. Additionally, DN drive electrodes 307a/307b and DP drive electrodes 308a/308b and corresponding MB electrodes 309 on the frame 303 are used to drive motion of the frame 303 and the bulk substrate proof mass 301.

Thus, the bulk substrate proof mass 301 is driven in a first direction (for example an X-direction) while motion of the bulk substrate proof mass 301 arising from the Coriolis effect is detected in a second direction (for example, a Y-direction).

Although one example of a gyroscope 300 is shown in FIG. 11, the teachings herein can be used to implemented gyroscopes in a wide variety of ways. Accordingly, other implementations are possible.

### Conclusion

The foregoing description may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while the disclosed embodiments are presented in a given arrangement, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. The various features and processes described above may be implemented independently of one another or may be combined in various ways. All possible combinations and sub-combinations of features of this disclosure are intended to fall within the scope of this disclosure.

What is claimed is:

1. An inertial sensor comprising:
a bulk substrate;
a bulk substrate proof mass formed from a portion of the bulk substrate; and
a sensing structure configured to detect a relative motion between the bulk substrate and the bulk substrate proof mass.

2. The inertial sensor of claim 1, further comprising a separate processing layer from the bulk substrate, wherein the sensing structure is formed in the separate processing layer.

3. The inertial sensor of claim 1, wherein the bulk substrate includes a handle region and an upper region over the handle region, wherein the bulk substrate proof mass is formed from the upper region of the bulk substrate.

4. The inertial sensor of claim 3, wherein the handle region forms a bottom cap of an encapsulation structure that encapsulates the proof mass and the sensing structure.

5. The inertial sensor of claim 4, wherein the encapsulation structure further includes a top cap formed over the proof mass and the sensing structure.

6. The inertial sensor of claim 1, wherein the bulk substrate includes a cavity, wherein the bulk substrate proof mass is suspended in the cavity by a plurality of spring tethers.

7. The inertial sensor of claim 6, wherein the plurality of spring tethers are formed from the bulk substrate.

8. The inertial sensor of claim 1, wherein the sensing structure is a capacitive sensing structure including one or more first electrodes attached to the bulk substrate proof mass and one or more second anchored to the bulk substrate, the one or more first electrodes and the one or more second electrodes forming at least one of a comb finger set or a parallel plate electrode set.

9. The inertial sensor of claim 1, further comprising a frame formed from the bulk substrate and positioned between the bulk substrate proof mass and the bulk substrate.

10. The inertial sensor of claim 9, wherein the sensing structure is a capacitive sensing structure including one or more first electrodes attached to the bulk substrate proof mass and one or more second electrodes anchored to the frame, the one or more first electrodes and the one or more second electrodes forming at least one of a comb finger set or a parallel plate electrode set.

11. The inertial sensor of claim 1, wherein the sensing structure is a capacitive sensing structure including a first electrode set and a second electrode set configured to generate a differential output signal, wherein at least one electrode of the first electrode set and at least one electrode of the second electrode set are both attached to the bulk substrate proof mass.

12. The inertial sensor of claim 1, wherein the sensing structure is a capacitive sensing structure including an electrode set, wherein at least one electrode of the electrode set is suspended over the bulk substrate proof mass.

13. A method of forming an inertial sensor, the method comprising:
forming a bulk substrate proof mass from a portion of a bulk substrate; and
forming a sensing structure coupled to the bulk substrate, the capacitance sensing structure detecting a relative motion between the bulk substrate and the bulk substrate proof mass.

14. The method of claim 13, wherein the bulk substrate includes a handle region and an upper region over the handle region, wherein the bulk substrate proof mass is formed from the upper region of the bulk substrate.

15. The method of claim 14, wherein the handle region forms a bottom cap of an encapsulation structure that encapsulates the proof mass and the sensing structure.

16. The method of claim 15, wherein the encapsulation structure further includes a top cap formed over the proof mass and the sensing structure.

17. The method of claim 13, wherein the bulk substrate includes a cavity, wherein the bulk substrate proof mass is suspended in the cavity by a plurality of spring tethers.

18. The method of claim 17, wherein the plurality of spring tethers are formed from the bulk substrate.

19. The method of claim 13, wherein the sensing structure is a capacitive sensing structure including one or more moveable fingers attached to the bulk substrate proof mass and one or more fixed fingers.

20. The method of claim 13, further comprising a frame formed from the bulk substrate and positioned between the bulk substrate proof mass and the bulk substrate.
